(19) United States
(12) Patent Application Publication
(10) Pub. No.: US 2026/0023914 A1
(43) Pub. Date: Jan. 22, 2026

(54) INTEGRATED CIRCUIT DESIGN BASED ON TIMING SLACK

(71) Applicant: INTERNATIONAL BUSINESS MACHINES CORPORATION, ARMONK, NY (US)

(72) Inventors: CHRIS CAVITT, QUEENSBURY, NY (US); GERALD L. STREVIG, III, CEDAR PARK, TX (US); DAVID WOLPERT, POUGHKEEPSIE, NY (US); GEOFFERY A. NUDGE, POUGHKEEPSIE, NY (US)

(21) Appl. No.: 18/778,544

(22) Filed: Jul. 19, 2024

(51) Int. Cl. G06F 30/398; G06F 30/392; G06F 119/12

(52) U.S. Cl. CPC G06F 30/398; G06F 30/392; G06F 2119/12

(57) ABSTRACT

Integrated circuit (IC) design based on timing slack according to an example includes accessing physical design data for an IC layout, wherein the physical design data comprises a netlist including active metal shapes of a metal shapes infrastructure forming signal path nets connecting different parts of the IC layout. Timing-based design rule checking of the physical design data is performed to identify slack stealing information for the signal path nets. Shape-based density design rule checking of the metal shapes infrastructure is performed, based on the slack stealing information, to perform fill insertion of metal fill shapes to satisfy density requirements in the IC layout.

### BACKGROUND

The present disclosure relates to methods, apparatus, and products for integrated circuit design based on timing slack.

### SUMMARY

According to embodiments of the present disclosure, various methods, apparatus and products for integrated circuit (IC) design based on timing slack are described herein. In some aspects, IC design based on timing slack includes accessing physical design data for an IC layout, wherein the physical design data comprises a netlist including active metal shapes of a metal shapes infrastructure forming signal path nets connecting different parts of the IC layout. Timing-based design rule checking of the physical design data is performed to identify slack stealing information for the signal path nets. Shape-based density design rule checking of the metal shapes infrastructure is performed, based on the slack stealing information, to perform fill insertion of metal fill shapes to satisfy density requirements in the IC layout.

### BRIEF DESCRIPTION OF THE DRAWINGS

FIG. 1 sets forth an example computing environment according to aspects of the present disclosure.

FIG. 2 illustrates an example system for implementing timing slack stealing aware fill optimization for an IC layout according to aspects of the present disclosure.

FIG. 3 sets forth a flowchart illustrating example operations of a method for timing slack stealing aware fill optimization for an IC layout according to aspects of the present disclosure.

FIG. 4 sets forth a flowchart illustrating example operations of a method for timing slack stealing aware fill optimization based on critical-first fill according to aspects of the present disclosure.

FIG. 5 sets forth a flowchart illustrating example operations of a method for timing slack stealing aware fill optimization based on non-critical-first fill according to aspects of the present disclosure.

FIG. 6 sets forth a flowchart of an example method for IC design based on timing slack according to further aspects of the present disclosure.

### DETAILED DESCRIPTION

An IC or chip includes active devices or logic shapes forming electrical circuits, with metal wiring structures including active wire shapes connecting the active devices together. The active wire shapes form wiring metallization including multiple metal layers (e.g., 12 to 18 metal layers in a stack) in a back-end-of-line (BEOL) processing region of the chip, and form power and signal path nets connecting the different circuit logic together. Metal density fill includes metal fill shapes that are distinct from the main power and signal path design shapes, and that are added to the wiring metallization of an IC design (e.g., beyond active power and signal wiring shapes used for circuit logic), to satisfy metal density rules or patterning requirements for chip fabrication. A foundry often defines different density constraints (e.g., minimum metal density and maximum metal density rules) at a cell level and global chip level to meet metal density requirements for its IC fabrication processes. Some existing systems run fill algorithms on each metal layer to ensure that a total metal density falls within a defined minimum density and maximum density range to meet patterning requirements. Metal fill density checks typically include a set of density checks (e.g., planar and vertical gradient density checks, and multi-layer density checks) and include considerations of tile location differences between cell-level and chip-level.

While the metal density rules provided by a foundry may avoid irregularities in a patterning process of the chip fabrication, unfortunately, added metal fill shapes can cause additional capacitance (e.g., planar capacitance and vertical capacitance) that affects the signal path nets and logic shapes, resulting in wasted power and performance issues for the chip. New techniques are needed for implementing metal density fill in an IC design layout that avoids excessive impact to power and signals and enables overall effective chip power/performance efficiency.

Some examples disclosed herein are directed to techniques for optimizing placement of metal fill shapes and optimizing metal fill density to achieve effective performance in an IC design using computer software tools. Embodiments of the present invention provide a circuit design fill process that is based on awareness of stealing timing slack, known hereinafter as “timing slack stealing aware fill” process. Some examples provide timing slack stealing aware fill optimization, limiting added metal fill shapes that most significantly impact signal timing characteristics, while maintaining sufficient metal fill shapes to meet minimum metal density requirements. The timing slack stealing aware fill optimization according to some examples uses information regarding the stealing of timing slack (e.g., information regarding the distribution of excess timing margin from one portion of a path to another portion of the path) in a design as part of optimizing the fill process. The disclosed techniques enable IC designs to achieve global optimal timing characteristics for a given density pattern tile while limiting planar capacitance and vertical capacitance of a net associated with the density pattern tile from a specific metal fill shape. The disclosed techniques enable a fill optimization design tool to identify the existing metal tile density and provide timing slack stealing aware metal fill insertion to specifically target a minimum metal density threshold to satisfy density requirements of the IC design, and based on considerations of tile location differences between cell-level and chip-level, gradient density checks, and multi-layer density checks.

Some examples disclosed herein enable optimal timing slack stealing aware metal fill insertion to non-critical signal path locations to achieve minimum density requirements, with automated processing to identify target active shapes for optimal metal fill insertion (e.g., adding, removing, or moving metal fill shapes) based on the signal impact of added metal fill shapes to the target active shapes. In addition, the proposed techniques may be used for adding metal fill shapes to minimize delay, and to intentionally add delay to signal paths that may otherwise arrive too quickly at their destination gates, i.e., to identify metal fill shapes insertion to minimize timing delay to signal paths, and to increase timing delay to signal paths.

Some examples of the present disclosure are directed to cross-hierarchy (e.g., paths crossing multiple layers of design hierarchy that may be designed independently) time sharing for optimized fill reduction. Some examples are directed to cross-hierarchy fill optimization for power-performance efficiency. Some examples are directed to a patterning density tool with cross-latch timing awareness for fill placement optimization. Some examples are directed to a patterning density tool prioritizing fill optimization of slack-per-device-threshold targets to adjust device threshold voltage selection within a slack budget. Some examples of the present disclosure include a timing flow that has the ability to distribute excess timing margin (e.g., excess timing slack) from one portion of a path across latches to another portion of the path, which may be referred to herein as slack stealing or delay borrowing. Adjusting the timing slack across latches in a path may be modeled, and the timing impact can happen across hierarchical boundaries. The timing slack may have a slew component as well. Some examples use timing information including slack stealing information to perform fill manipulation that targets critical paths that require additional timing margin, and can result in changes to both critical and non-critical path timing slacks because of the manipulation of fill patterns from one place on the chip to another.

Some examples disclosed herein account for slack stealing when space is being allocated for fill shape manipulations. In some examples, for latches within a block, the system accounts for a timing slack window (including, in some examples, pulse width of clock, slack of next cycle, and guard banding) when the system is defining if each segment is part of a critical path or not. Some examples of the timing-aware fill techniques disclosed herein may be used to further improve a critical path segment by affecting slack adjustment to a prior or subsequent portion of the path even if the segment in question is not critical by itself. In some examples, for latches across hierarchy, the pin assumptions may be that the maximum delay has already been borrowed from the segment, so timing constraints for the path segments associated with those signal pins may be treated as a potential need for fill limitation.

In some examples, the fill tooling sees a reported delay per path segment, and at multiple layers of hierarchy. In some examples, fill shapes are moved/removed based on the given slack in paths, with attention paid to upstream/downstream impacts and awareness of power impact. Some examples include a feedback loop between the timing-aware fill tooling, timing tooling, and place/route tooling to facilitate: (1) prioritizing fill removal on paths with no additional cycle stealing available for initial fill removal; (2) including cross-hierarchy timing assertions when calculating cycle stealing availability; and (3) combining these techniques to identify delay thresholds at which cells in the path can be downgraded to lower-power devices.

An example of the present disclosure is directed to a method for integrated circuit (IC) design based on timing slack, which includes accessing physical design data for an IC layout, where the physical design data comprises a netlist including active metal shapes of a metal shapes infrastructure forming signal path nets connecting different parts of the IC layout. The method includes performing timing-based design rule checking of the physical design data to identify slack stealing information for the signal path nets. The method includes performing shape-based density design rule checking of the metal shapes infrastructure, based on the slack stealing information, to perform fill insertion of metal fill shapes to satisfy density requirements in the IC layout.

Examples of the method include various technical features that yield technical effects that provide various improvements to computer technology. For instance, some examples include the technical features of performing timing-based design rule checking of the physical design data to identify slack stealing information for the signal path nets, and performing shape-based density design rule checking of the metal shapes infrastructure, based on the slack stealing information, to perform fill insertion of metal fill shapes to satisfy density requirements in the IC layout. These technical features yield the technical effect of providing metal density fill in an IC design layout that avoids excessive impact to power and signals and enables overall effective chip power/performance efficiency. Some examples provide timing slack stealing aware fill optimization, limiting added metal fill shapes that most significantly impact signal timing characteristics, while maintaining sufficient metal fill shapes to meet minimum metal density requirements.

In some examples of the method, the slack stealing information includes timing slack values for the active metal shapes of the metal shapes infrastructure, and the slack stealing information indicates excess timing slack that may be distributed from one portion of a signal path net across one or more latches to another portion of that signal path net. These technical features yield the technical effect of providing cross-latch slack stealing aware fill optimization which takes into account excess timing slack that may be distributed from one portion of a path across latches to another portion of the path to avoid excessive impact to power and signals and enable overall effective chip power/performance efficiency.

Some examples of the method further include performing the timing-based design rule checking to identify the slack stealing information based at least in part on cross-hierarchy timing assertions. These technical features yield the technical effect of providing cross-hierarchy slack stealing aware fill optimization which takes into account cross-hierarchy timing assertions to avoid excessive impact to power and signals and enable overall effective chip power/performance efficiency.

Some examples of the method further include identifying a set of the signal path nets that have no slack stealing available, and prioritizing fill removal on the identified set of signal path nets for initial fill removal. These technical features yield the technical effect of using slack stealing information to perform fill limitation that targets critical paths with no slack stealing available to avoid excessive impact of fill to these paths and enable overall effective chip power/performance efficiency.

Some examples of the method further include identifying slack stealing thresholds at which devices in one or more of the signal path nets can be downgraded to lower-power devices. These technical features yield the technical effect of using slack stealing information to downgrade to lower-power devices to provide overall effective chip power efficiency.

Some examples of the method further include identifying critical signal path nets based on the slack stealing information for the signal path nets, and performing the shape-based density design rule checking of the critical signal path nets before performing shape-based density design rule checking of other signal path nets. These technical features yield the technical effect of using slack stealing information to perform the shape-based density design rule checking on critical paths first to avoid excessive impact of fill to these critical paths and enable overall effective chip power/performance efficiency.

In some examples of the method, performing the shape-based density design rule checking of the critical signal path nets further includes assigning three-dimensional track spacings based on timing slack thresholds of the critical signal path nets, and performing the fill insertion of metal fill shapes based on the timing slack thresholds of respective critical signal path nets to achieve a predefined minimum density threshold to satisfy density requirements in the IC layout. These technical features yield the technical effect of using slack stealing information to perform the shape-based density design rule checking on critical paths including using three-dimensional track spacings to avoid excessive impact of fill in three dimensions to these critical paths and enable overall effective chip power/performance efficiency.

Some examples of the method further include classifying, based on the slack stealing information, the signal path nets into three or more classes, and limiting fill insertion of metal fill shapes based on the three or more classes. These technical features yield the technical effect of using slack stealing information to perform fill limitation that targets paths based on their classification to avoid excessive impact of fill to certain paths and enable overall effective chip power/performance efficiency.

In some examples of the method, the signal path nets are classified into the three or more classes based on whether active metal shapes forming each of the signal path nets are critical active metal shapes or non-critical active metal shapes. These technical features yield the technical effect of using slack stealing information to perform fill limitation that targets paths based on their classification, which is based on critical active metal shapes and non-critical active metal shapes, to avoid excessive impact of fill to critical paths and enable overall effective chip power/performance efficiency.

In some examples of the method, performing shape-based density design rule checking of the metal shapes infrastructure further includes assigning priorities of the active metal shapes forming the signal path nets into the metal shapes infrastructure based on the slack stealing information. These technical features yield the technical effect of using the slack stealing information to assign priorities into the metal shapes infrastructure to facilitate fill manipulation that avoids excessive impact to power and signals and enables overall effective chip power/performance efficiency.

Another example of the present disclosure is directed to a system for integrated circuit (IC) design based on timing slack, which includes a first design tool to access physical design data for an IC layout, where the physical design data comprises a netlist including active metal shapes of a metal shapes infrastructure forming signal path nets connecting different parts of the IC layout, and where the first design tool is to perform timing-based design rule checking of the physical design data to identify slack stealing information for the signal path nets. The system includes a second design tool to perform shape-based density design rule checking of the metal shapes infrastructure, based on the slack stealing information, to perform fill insertion of metal fill shapes to satisfy density requirements in the IC layout.

Examples of the system include various technical features that yield technical effects that provide various improvements to computer technology. For instance, some examples include the technical features of a first design tool to perform timing-based design rule checking of the physical design data to identify slack stealing information for the signal path nets, and a second design tool to perform shape-based density design rule checking of the metal shapes infrastructure, based on the slack stealing information, to perform fill insertion of metal fill shapes to satisfy density requirements in the IC layout. These technical features yield the technical effect of providing metal density fill in an IC design layout that avoids excessive impact to power and signals and enables overall effective chip power/performance efficiency. Some examples provide timing slack stealing aware fill optimization, limiting added metal fill shapes that most significantly impact signal timing characteristics, while maintaining sufficient metal fill shapes to meet minimum metal density requirements.

In some examples of the system, the slack stealing information includes timing slack values for the active metal shapes of the metal shapes infrastructure, and the slack stealing information indicates excess timing slack that may be distributed from one portion of a signal path net across one or more latches to another portion of that signal path net. These technical features yield the technical effect of providing cross-latch slack stealing aware fill optimization which takes into account excess timing slack that may be distributed from one portion of a path across latches to another portion of the path to avoid excessive impact to power and signals and enable overall effective chip power/performance efficiency.

In some examples of the system, the first design tool is to perform the timing-based design rule checking to identify the slack stealing information based at least in part on cross-hierarchy timing assertions. These technical features yield the technical effect of providing cross-hierarchy slack stealing aware fill optimization which takes into account cross-hierarchy timing assertions to avoid excessive impact to power and signals and enable overall effective chip power/performance efficiency.

Some examples of the system further include one or more tools to identify a set of the signal path nets that have no slack stealing available, and prioritize fill removal on the identified set of signal path nets for initial fill removal. These technical features yield the technical effect of using slack stealing information to perform fill limitation that targets critical paths with no slack stealing available to avoid excessive impact of fill to these paths and enable overall effective chip power/performance efficiency.

Some examples of the system further include one or more tools to identify slack stealing thresholds at which devices in one or more of the signal path nets can be downgraded to lower-power devices. These technical features yield the technical effect of using slack stealing information to downgrade to lower-power devices to provide overall effective chip power efficiency.

Some examples of the system further include one or more tools to classify, based on the slack stealing information, the signal path nets into three or more classes, and limiting fill insertion of metal fill shapes based on the three or more classes. These technical features yield the technical effect of using slack stealing information to perform fill limitation that targets paths based on their classification to avoid excessive impact of fill to certain paths and enable overall effective chip power/performance efficiency.

Another example of the present disclosure is directed to an apparatus for integrated circuit (IC) design based on timing slack, which includes a processing device, and a memory operatively coupled to the processing device. The memory stores computer program instructions that, when executed, cause the processing device to access physical design data for an IC layout, where the physical design data comprises a netlist including active metal shapes of a metal shapes infrastructure forming signal path nets connecting different parts of the IC layout. The memory stores computer program instructions that, when executed, cause the processing device to perform timing-based design rule checking of the physical design data to identify slack stealing information for the signal path nets. The memory stores computer program instructions that, when executed, cause the processing device to perform shape-based density design rule checking of the metal shapes infrastructure, based on the slack stealing information, to perform fill insertion of metal fill shapes to satisfy density requirements in the IC layout.

Examples of the apparatus include various technical features that yield technical effects that provide various improvements to computer technology. For instance, some examples include the technical features of perform timing-based design rule checking of the physical design data to identify slack stealing information for the signal path nets, and perform shape-based density design rule checking of the metal shapes infrastructure, based on the slack stealing information, to perform fill insertion of metal fill shapes to satisfy density requirements in the IC layout. These technical features yield the technical effect of providing metal density fill in an IC design layout that avoids excessive impact to power and signals and enables overall effective chip power/performance efficiency. Some examples provide timing slack stealing aware fill optimization, limiting added metal fill shapes that most significantly impact signal timing characteristics, while maintaining sufficient metal fill shapes to meet minimum metal density requirements.

In some examples of the apparatus, the slack stealing information includes timing slack values for the active metal shapes of the metal shapes infrastructure, and the slack stealing information indicates excess timing slack that may be distributed from one portion of a signal path net across one or more latches to another portion of that signal path net. These technical features yield the technical effect of providing cross-latch slack stealing aware fill optimization which takes into account excess timing slack that may be distributed from one portion of a path across latches to another portion of the path to avoid excessive impact to power and signals and enable overall effective chip power/performance efficiency.

In some examples of the apparatus, the memory stores computer program instructions that, when executed, cause the processing device to perform the timing-based design rule checking to identify the slack stealing information based at least in part on cross-hierarchy timing assertions. These technical features yield the technical effect of providing cross-hierarchy slack stealing aware fill optimization which takes into account cross-hierarchy timing assertions to avoid excessive impact to power and signals and enable overall effective chip power/performance efficiency.

In some examples of the apparatus, the memory stores computer program instructions that, when executed, cause the processing device to identify a set of the signal path nets that have no slack stealing available, and prioritize fill removal on the identified set of signal path nets for initial fill removal. These technical features yield the technical effect of using slack stealing information to perform fill limitation that targets critical paths with no slack stealing available to avoid excessive impact of fill to these paths and enable overall effective chip power/performance efficiency.

Another example of the present disclosure is directed to a computer program product including a computer readable storage medium. The computer readable storage medium includes computer program instructions that, when executed, access physical design data for an integrated circuit (IC) layout, where the physical design data comprises a netlist including active metal shapes of a metal shapes infrastructure forming signal path nets connecting different parts of the IC layout. The computer readable storage medium includes computer program instructions that, when executed, perform timing-based design rule checking of the physical design data to identify slack stealing information for the signal path nets. The computer readable storage medium includes computer program instructions that, when executed, perform shape-based density design rule checking of the metal shapes infrastructure, based on the slack stealing information, to perform fill insertion of metal fill shapes to satisfy density requirements in the IC layout.

Examples of the computer program product include various technical features that yield technical effects that provide various improvements to computer technology. For instance, some examples include the technical features of perform timing-based design rule checking of the physical design data to identify slack stealing information for the signal path nets, and perform shape-based density design rule checking of the metal shapes infrastructure, based on the slack stealing information, to perform fill insertion of metal fill shapes to satisfy density requirements in the IC layout. These technical features yield the technical effect of providing metal density fill in an IC design layout that avoids excessive impact to power and signals and enables overall effective chip power/performance efficiency. Some examples provide timing slack stealing aware fill optimization, limiting added metal fill shapes that most significantly impact signal timing characteristics, while maintaining sufficient metal fill shapes to meet minimum metal density requirements.

In some examples of the computer program product, the slack stealing information includes timing slack values for the active metal shapes of the metal shapes infrastructure, and the slack stealing information indicates excess timing slack that may be distributed from one portion of a signal path net across one or more latches to another portion of that signal path net. These technical features yield the technical effect of providing cross-latch slack stealing aware fill optimization which takes into account excess timing slack that may be distributed from one portion of a path across latches to another portion of the path to avoid excessive impact to power and signals and enable overall effective chip power/performance efficiency.

In some examples of the computer program product, the computer readable storage medium includes computer program instructions that, when executed, perform the timing-based design rule checking to identify the slack stealing information based at least in part on cross-hierarchy timing assertions. These technical features yield the technical effect of providing cross-hierarchy slack stealing aware fill optimization which takes into account cross-hierarchy timing assertions to avoid excessive impact to power and signals and enable overall effective chip power/performance efficiency.

Another example of the present disclosure is directed to a method for integrated circuit (IC) design based on timing slack, which includes accessing physical design data for an IC layout, wherein the physical design data comprises a netlist including active metal shapes of a metal shapes infrastructure forming signal path nets connecting different parts of the IC layout. The method includes performing timing-based design rule checking of the physical design data to identify cross-latch and cross-hierarchy slack stealing information for the signal path nets. The method includes performing shape-based density design rule checking of the metal shapes infrastructure, based on the slack stealing information, to perform fill insertion of metal fill shapes to satisfy density requirements in the IC layout.

Examples of the method include various technical features that yield technical effects that provide various improvements to computer technology. For instance, some examples include the technical features of performing timing-based design rule checking of the physical design data to identify cross-latch and cross-hierarchy slack stealing information for the signal path nets, and performing shape-based density design rule checking of the metal shapes infrastructure, based on the slack stealing information, to perform fill insertion of metal fill shapes to satisfy density requirements in the IC layout. These technical features yield the technical effect of providing metal density fill in an IC design layout that avoids excessive impact to power and signals and enables overall effective chip power/performance efficiency. Some examples provide timing slack stealing aware fill optimization, limiting added metal fill shapes that most significantly impact signal timing characteristics, while maintaining sufficient metal fill shapes to meet minimum metal density requirements.

In some examples of the method, the slack stealing information includes timing slack values for the active metal shapes of the metal shapes infrastructure, and the slack stealing information is based at least in part on cross-hierarchy timing assertions and indicates excess timing slack that may be distributed from one portion of a signal path net across one or more latches to another portion of that signal path net. These technical features yield the technical effect of providing cross-latch and cross-hierarchy slack stealing aware fill optimization which takes into account cross-hierarchy timing assertions and excess timing slack that may be distributed from one portion of a path across latches to another portion of the path to avoid excessive impact to power and signals and enable overall effective chip power/performance efficiency.

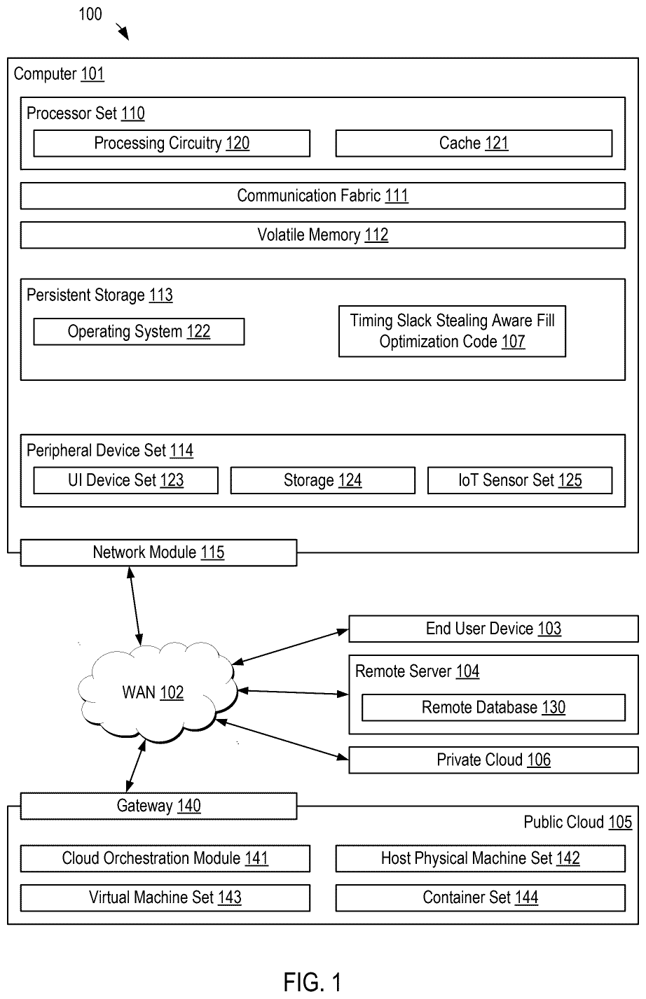

FIG. 1 sets forth an example computing environment according to aspects of the present disclosure. Computing environment 100 contains an example of an environment for the execution of at least some of the computer code involved in performing the various methods described herein, such as timing slack stealing aware fill optimization code 107. In addition to timing slack stealing aware fill optimization code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and timing slack stealing aware fill optimization code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in timing slack stealing aware fill optimization code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in timing slack stealing aware fill optimization code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

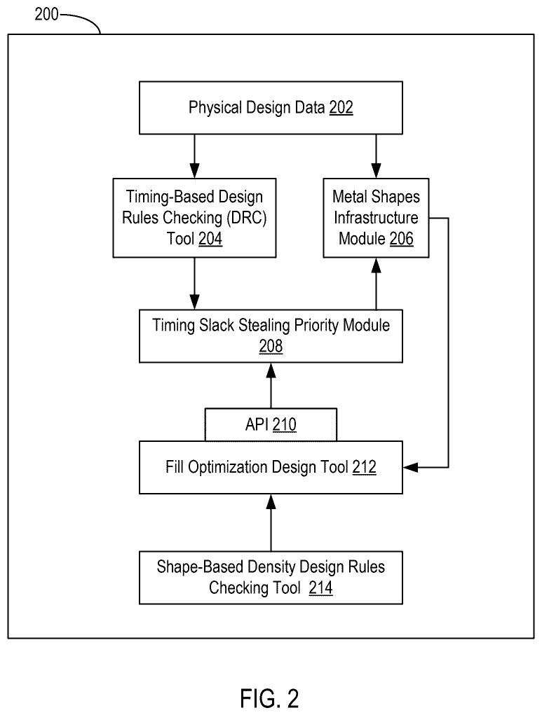

FIG. 2 illustrates an example system 200 for implementing timing slack stealing aware fill optimization for an IC layout according to aspects of the present disclosure. System 200 can be used in conjunction with the computing environment 100 of FIG. 1, including the timing slack stealing aware fill optimization code 107 for implementing methods according to one or more examples.

System 200 performs disclosed methods for optimally providing metal fill shapes based on determined cell and overall chip timing impacts of the added fill shapes. In an example, metal fill shapes are added in available empty areas on the metal layers to satisfy minimum metal fill density requirements for the chip, using metal fill density rules provided by a foundry or fabrication facility, together with timing slack stealing knowledge obtained for the chip. System 200 performs techniques for adding metal fill shapes in an IC layout that significantly limit the timing impact of the added metal fill shapes on the chip (e.g., limits adding metal fill shapes impacting gate driven signals of critical active metal signal wires or nets) based on cell and overall chip timing results, while adding sufficient metal fill shapes near non-critical active metal signal wires or nets to meet the fill density requirements. System 200 can optimally add metal fill shapes to achieve predefined minimum density requirements, while automating the process of identifying critical and non-critical path locations of active metal shapes for metal fill shapes placement based on net signal path timing characteristics and timing slack stealing information, advantageously used for adding metal fill shapes.

System 200 includes physical design data 202 for a given IC layout. For example, system 200 obtains the physical design data 202, which includes a netlist representing different parts of the IC that are connected together in the IC layout, active metal shapes and their locations that connect the different parts in the IC layout, fill metal shapes, circuit shapes, active logic shapes, sub-circuits, cell and macro designs, and the like, which represent regions to be manufactured on different layers of the IC.

System 200 includes a metal shapes infrastructure module 206, which may include computer code to identify active metal shapes and fill metal shapes of the physical design data 202 that form a chip metallization or metal shapes infrastructure comprising multiple metal layers of the IC layout. For example, the active metal and fill metal shapes may include rectangles or rectilinear polygons (although other predefined shapes may be used), which represent active metal and fill wiring regions to be manufactured on different metal layers of the IC layout.

System 200 includes a timing-based design rule checking (DRC) tool 204, which may include computer code to inspect a netlist of the physical design data 202 for the IC layout and identify net timing characteristics and timing slack stealing information of signal path nets and net timing properties of the active metal shapes of the IC design, which form the signal path nets. The timing-based DRC tool 204 is used to ensure the net timing characteristics of signal path nets meet IC design manufacturing requirements and will not result in a chip failure.

System 200 implements prioritization of fill metal shapes and signal path nets using a timing slack stealing priority module 208 coupled to the timing-based DRC tool 204. The timing slack stealing priority module 208 may include computer code to assign fill priorities based on timing characteristics and timing slack stealing information of the signal path nets and net timing properties of the active metal shapes obtained by the timing-based DRC tool 204 (e.g., using net timing properties or attributes of the active metal shapes) for each metal shape. System 200 provides the assigned fill priorities for fill metal shapes and signal path nets into the metal shapes infrastructure module 206 for the IC layout.

For example, fill priorities based on timing slack stealing information may be provided into metal shapes infrastructure module 206 via properties of the shapes, and timing or priority information may be polled based on each shape's net attributes (e.g., net name). The priorities stored as properties may include timing slack values and/or timing fill priorities, such as represented by:

$$[ Timing\_slack + 100 / … / + 1 / 0 / - 1 / … / - 100 ] and / or \\ [ Timing\_fill \_priority 1 / 2 / … / 1 , 000 , 000 , 000 ]$$

For example, the timing property called timing slack generally represents how much extra time a given net has for a signal to propagate from a net source to a net sink. In an example, for a net with a high timing slack value such as +100, a significant amount of metal fill shapes can be added around this net (e.g., without significantly impacting net clocking considerations). Alternatively, for a net with a low timing slack value such as +1, adding metal fill shapes should be avoided or limited away from this net because the added capacitance from the metal fill may impact net timing characteristics, and cause the net to have a negative timing slack value.

System 200 may distribute excess timing slack from one portion of a path across latches to another portion of the path. In some examples, based on timing slack stealing information, timing slack stealing priority module 208 may determine, for each path segment, whether the segment is part of a critical path or not. Timing slack stealing priority module 208 may prioritize fill removal on paths with no additional slack stealing available for initial fill removal, and may include cross-hierarchy timing assertions when calculating slack stealing availability. Timing slack stealing priority module 208 may also identify delay thresholds at which cells in a path can be downgraded to lower-power devices. Slack stealing priority module 208 may use slack stealing information to perform prioritization to provide fill manipulation that targets critical paths that require additional timing margin, and can result in changes to both critical and non-critical path timing slacks because of the manipulation of fill patterns from one place on the chip to another.

In some examples, timing slack stealing priority module 208 classifies each signal path net into one of three classes or categories: (1) a first class for paths with a path segment that is non-critical and a prior/subsequent path segment that is also non-critical; (2) a second class for paths with a path segment that is non-critical and a prior/subsequent path segment is critical (or is feeding a pin with an unknown timing constraint); and (3) a third class for paths with a path segment that is critical and the prior/subsequent path segment is also critical. In some examples, paths that fall into the first class are prioritized by priority module 208 such that there are no limitations put on the fill around these paths. Paths that fall into the second class may be prioritized by priority module 208 for fill limitation over paths that fall into the first class. Paths that fall into the third class may be prioritized by priority module 208 for first-pass limitation of adjacent and/or vertically overlapping fill. In some examples, priority module 208 may create a pin-based listing to indicate to a parent (i.e., a block containing the block in question) or child (i.e., a block contained within the block in question) how much potential additional timing benefit could be achieved by a block at a different level of hierarchy.

In some examples, for primary inputs and primary outputs, a parent block may provide assertions that indicate when to assume signals arrive at input pins, and what time signals are required to leave at the output pins. In some examples, there may be no guarantee that these assertions are accurate, or that the designer has kept them up to date with the parent implementation. Because of this uncertainty, some examples may use special policies for paths that interact with primary inputs and primary outputs, and determine timing slack stealing information and priority information for these paths based on the special policies. For example, for a latch fed by a primary input, the system 200 may steal the maximum possible timing slack from the internal latch to latch path until the cutoff slack is hit or the falling local clock setup fails. This gives the parent level as much slack as possible for its in-context slack adjustment. For a latch that feeds a primary output, the system 200 may steal the minimum slack from the output needed to make the input of the latch positive. For a latch that is fed by a primary input and feeds a primary output, the system 200 may not trust the assertions and disallow slack stealing in this case.

Some examples of the physical design data 202 may use boundary abstracts, and additional information regarding downstream latch to latch paths may be stored to prevent the parent from over stealing into the next cycle. For example, assume that a macro includes a primary input feeding a first latch (with −10 picosecond (ps) slack), and the first latch feeds a second latch via a first path segment (with +5 ps slack) and feeds a primary output via a second path segment (with −15 ps slack). When the macro runs out of context timing (i.e., without context of parent and/or child hierarchies), the first latch is fed by a primary input and is feeding a primary output, so slack stealing is disallowed for the macro run. Assume that the critical sink of the boundary latch (i.e., the first latch) is a +5 ps latch to latch path segment internally (i.e., the path segment from the first latch to the second latch). This path segment from the first latch to the second latch may be pruned from the abstract. The system may store in the abstract that there is Ops available for slack stealing, and that the critical output slack is +5 ps. The slacking stealing value in the abstract may be considered a floor value, and more slack can be stolen as long as it does not make the output slack annotated in the rule fall below 3 ps or cause the falling local clock setup test to fail. In this example, the system can steal 2 ps from the macro for the path feeding the primary input since the system stored data for a +5 ps out of context latch to latch path segment.

System 200 includes a fill optimization design tool 212, which may include computer code to perform fill optimization techniques to implement methods of the present disclosure. System 200 includes an application programming interface (API) 210 for the fill optimization design tool 212 to poll timing slack stealing information and priority information from the timing slack stealing priority module 208 based on each shape's net timing properties or attributes and the net timing characteristics of the signal path nets. For example, the net timing characteristics of the signal path nets may include timing signal slack, timing signal skew, and/or other timing slack stealing information. In response, slack stealing priority module 208 may access metal shapes infrastructure module 206 to obtain requested information. System 200 includes a shape-based density DRC tool 214, which may include computer code to verify whether a specific density fill design (e.g., at a cell level or macro level) meets the metal density constraints imposed by the process technology or foundry to be used for the chip manufacturing. The fill optimization design tool 212, using the shape-based density DRC tool 214 together with timing slack stealing information provided via the timing slack stealing priority module 208, implements fill placement for timing slack stealing aware metal fill optimization based on slack stealing information to ensure the IC design layout meets manufacturing metal density requirements and will not result in a chip failure.

In some examples, system 200 may build a dynamic timing approximation of timing impact resulting for each metal fill shape added into the metal shapes infrastructure and the fill optimization design tool 212 as the metal fill shapes are added. In some examples, as shapes are added, system 200 may maintain a running tally in the fill optimization design tool 212 of a potential timing impact resulting from each added metal fill shape. The cumulative net timing impact for the added metal fill shapes enables the fill optimization design tool 212 to ensure positive slack paths do not become negative slack paths and that weak negative slack paths do not swap priorities with other paths in the metal shapes infrastructure module 206. In some examples, identifying the potential timing impact for each added metal fill shape is used for building a dynamic approximation of cumulative timing impact for the fill insertion of the metal fill shapes.

Building the dynamic approximation of cumulative timing impact directly into the fill optimization design tool 212 as metal fill shapes are added enables the fill optimization design tool 212 to dynamically determine adverse effects of the added metal fill shapes and implement some additional guard bands or guardrails to avoid further adverse results of the fill insertion process. For example, the dynamic approximation of cumulative timing impact enables the fill optimization design tool 212 to avoid a negative net timing characteristics impact of specific signal path nets, such as changing non-critical signal path nets to critical signal path nets.

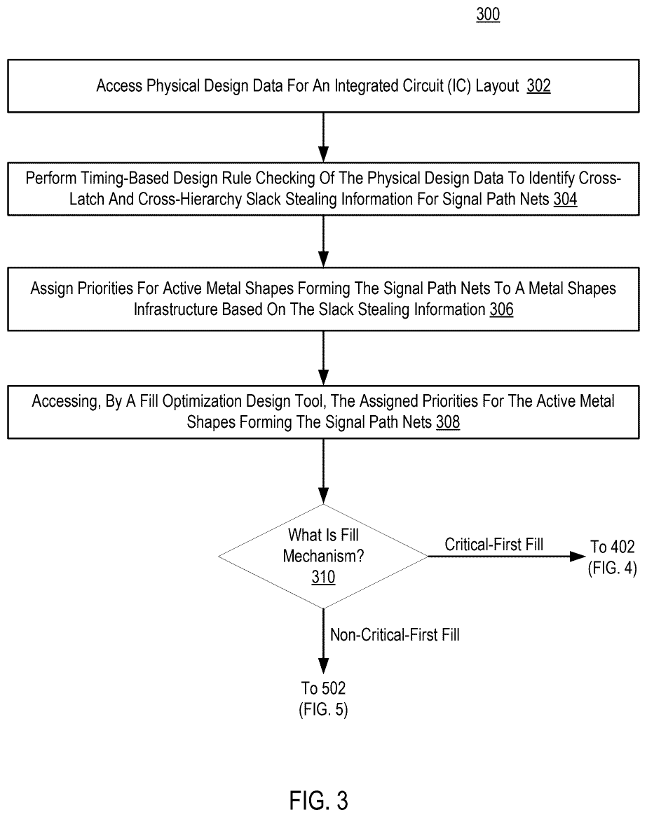

FIG. 3 sets forth a flowchart illustrating example operations of a method 300 for timing slack stealing aware fill optimization for an IC layout according to aspects of the present disclosure. In some examples, method 300 may be implemented by system 200 (FIG. 2) using the timing slack aware fill optimization code 107 (FIG. 1). Method 300 includes accessing 302 physical design data for an IC layout. For example, timing-based DRC tool 204 may access physical design data 202 comprising a netlist representing the different parts (e.g., nets or nodes, wires or signal path nets shapes, logic) to be connected, and active metal shapes including their locations that implement signal path nets connecting different parts of the IC layout).

Method 300 includes performing 304 timing-based design rules checking of the physical design data to identify cross-latch and cross-hierarchy slack stealing information for signal path nets. In an example, timing-based DRC tool 204 may perform the timing-based design rules checking on physical design data 202, which may include sequentially processing tiles of the layers of the physical design data 202 with the timing-based DRC tool 204 to identify timing results for signal paths and net timing attributes of each shape of the metal shapes infrastructure module 206. Method 300 includes assigning 306 priorities for active metal shapes forming the signal path nets to a metal shapes infrastructure based on the slack stealing information. In an example, timing slack stealing priority module 208 may perform the assigning priorities into each shape's property attributes in the metal shapes infrastructure module 206 based on the slack stealing information.

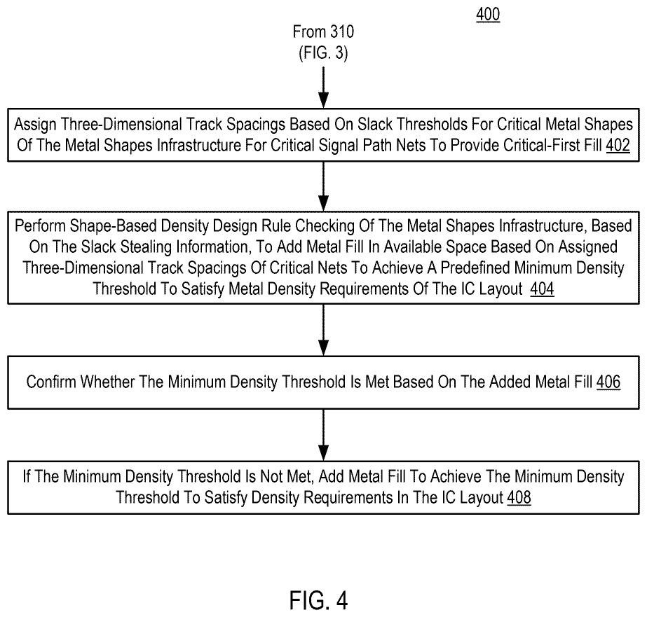

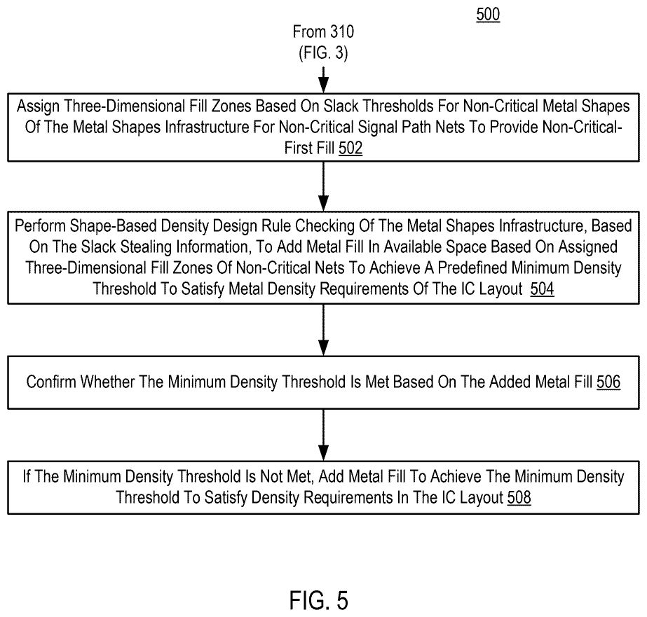

Method 300 includes accessing 308, by a fill optimization design tool, the assigned priorities for the active metal shapes forming the signal path nets. In an example, fill optimization design tool 212 may access the priorities from the timing slack stealing priority module 208 using API 210. Method 300 includes determining at 310 what the fill mechanism is. In some examples, system 200 identifies at 310 a fill mechanism of a critical-first fill or a non-critical-first fill for implementing timing slack stealing aware fill optimization for the IC layout. When a critical-first fill mechanism is identified at 310, operations continue at 402 in method 400 (FIG. 4). Alternatively, when a non-critical-first fill mechanism is identified at 310, operations continue at 502 in method 500 (FIG. 5).

FIG. 4 sets forth a flowchart illustrating example operations of a method 400 for timing slack stealing aware fill optimization based on critical-first fill according to aspects of the present disclosure. In some examples, method 400 may be implemented by system 200 (FIG. 2) using the timing slack aware fill optimization code 107 (FIG. 1). Method 400 includes assigning 402 three-dimensional track spacings based on timing slack thresholds for critical metal shapes of the metal shapes infrastructure for critical signal path nets to provide critical-first fill, where fill is added to critical signal path nets first. In some examples, the three-dimensional track spacings are created based on a three-dimensional timing slack stealing awareness of critical nets in the design, for example, with a keep-out shape that prohibits insertion of density fill, based on timing slack thresholds starting with critical signal path nets struggling to meet timing characteristics. In some examples, the assigned three-dimensional track spacings address both planar capacitance and vertical capacitance (i.e., keeping away from the neighboring tracks, such as keeping one wire away on each side of a critical signal path net, and keeping away from wires above and below the critical signal path net). In some examples, each three-dimensional track spacing defines a region around a critical signal path net based on respective timing slack thresholds, where adding metal fill is prevented or not allowed. For example, a −50 timing slack threshold means keeping away from neighboring tracks and prohibiting fill crossings on the layer above and the layer below the critical net struggling to meet timing characteristics. For example, a −5 slack may mean only keeping away from neighboring tracks. In some examples, keep-out enablements may be passed across shape hierarchy (e.g., if a critical path net is on a top metal layer).

Method 400 includes performing 404 shape-based density design rule checking of the metal shapes infrastructure, based on the slack stealing information, to add metal fill in available space (e.g., white space) based on the assigned three-dimensional track spacings of critical signal path nets to achieve a predefined minimum density threshold to satisfy metal density requirements of the IC layout. Alternatively, at 404 in method 400, in a design layout where metal fill exists within the assigned three-dimensional track spacings of critical nets, the system 200 can remove metal fill from the three-dimensional track spacing around critical signal path nets based on the assigned three-dimensional track spacings of critical signal path nets. Method 400 includes confirming 406 whether the minimum density threshold is met based on the added metal fill at 404 in method 400. Method 400 includes, if the minimum density threshold is not met as determined at 406 in method 400, adding 408 metal fill to achieve the minimum density threshold to satisfy density requirements in the IC layout.

FIG. 5 sets forth a flowchart illustrating example operations of a method 500 for timing slack stealing aware fill optimization based on non-critical-first fill according to aspects of the present disclosure. In some examples, method 500 may be implemented by system 200 (FIG. 2) using the timing slack aware fill optimization code 107 (FIG. 1). Method 500 includes assigning 502 three-dimensional fill zones based on timing slack thresholds for non-critical metal shapes of the metal shapes infrastructure for non-critical signal path nets to provide non-critical-first fill, where metal fill cells are added directly around non-critical signal path nets first. In some examples, the three-dimensional fill zones define a region around a non-critical signal path net based on respective timing slack thresholds, where metal fill is added.

Method 500 includes performing 504 shape-based density design rule checking, based on the slack stealing information, to add metal fill in available space based on the assigned three-dimensional fill zones of non-critical nets to achieve a predefined minimum density threshold to satisfy metal density requirements of the IC layout. In some examples, system 200 checks for critical planar and vertical neighboring wires (signal path nets), and adds planar metal fill adjacent non-critical wires and/or adds vertical metal fill around the non-critical wires based on the timing slack thresholds for the non-critical wires. For example, a +50 slack threshold can mean that as much vertical metal fill as possible should be added around that non-critical wire, but a +5 slack threshold means adding only planar fill. Alternatively, at 504 in method 500, in a design layout where metal fill exists within the assigned three-dimensional zones of non-critical signal path nets, the system 200 can remove vertical metal fill from the three-dimensional fill zones above and below non-critical signal path nets based on critical vertical neighboring wires (signal path nets). Method 500 includes confirming 506 whether the minimum threshold is met based on the added metal fill at 504 in method 500. Method 500 includes, if the minimum density threshold is not met as determined at 506 in method 500, adding 508 metal fill (e.g., adding vertical metal fill, or prioritizing vertical metal fill for reinsertion) to achieve the minimum density threshold to satisfy density requirements in the IC layout.

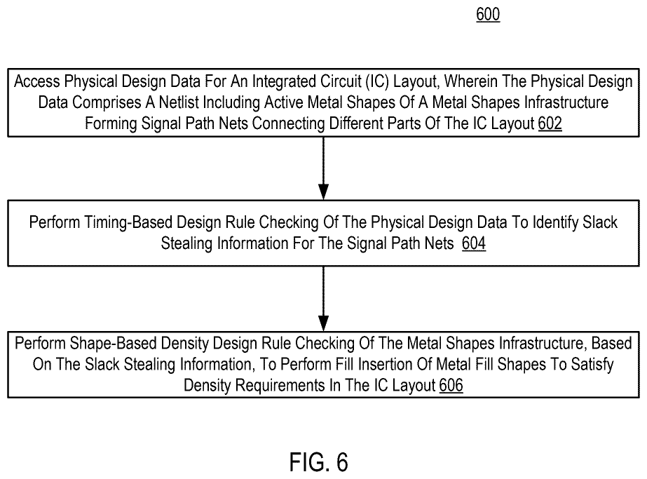

FIG. 6 sets forth a flowchart of an example method 600 for integrated circuit (IC) design based on timing slack according to further aspects of the present disclosure. In some examples, method 600 may be implemented by system 200 (FIG. 2) using the timing slack aware fill optimization code 107 (FIG. 1). Method 600 includes accessing 602 physical design data for an integrated circuit (IC) layout, wherein the physical design data comprises a netlist including active metal shapes of a metal shapes infrastructure forming signal path nets connecting different parts of the IC layout. Method 600 includes performing 604 timing-based design rule checking of the physical design data to identify slack stealing information for the signal path nets. In some examples, the slack stealing information may be cross-latch and cross-hierarchy slack stealing information. Method 600 includes performing 606 shape-based density design rule checking of the metal shapes infrastructure, based on the slack stealing information, to perform fill insertion of metal fill shapes to satisfy density requirements in the IC layout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for integrated circuit (IC) design based on timing slack comprising:
accessing physical design data for an IC layout, wherein the physical design data comprises a netlist including active metal shapes of a metal shapes infrastructure forming signal path nets connecting different parts of the IC layout;
performing timing-based design rule checking of the physical design data to identify slack stealing information for the signal path nets; and
performing shape-based density design rule checking of the metal shapes infrastructure, based on the slack stealing information, to perform fill insertion of metal fill shapes to satisfy density requirements in the IC layout.

2. The method of claim 1, wherein the slack stealing information includes timing slack values for the active metal shapes of the metal shapes infrastructure, and wherein the slack stealing information indicates excess timing slack that may be distributed from one portion of a signal path net across one or more latches to another portion of that signal path net.

3. The method of claim 1, and further comprising:
performing the timing-based design rule checking to identify the slack stealing information based at least in part on cross-hierarchy timing assertions.

4. The method of claim 1, and further comprising:
identifying a set of the signal path nets that have no slack stealing available; and
prioritizing fill removal on the identified set of signal path nets for initial fill removal.

5. The method of claim 1, and further comprising:
identifying slack stealing thresholds at which devices in one or more of the signal path nets can be downgraded to lower-power devices.

6. The method of claim 1, and further comprising;
identifying critical signal path nets based on the slack stealing information for the signal path nets; and
performing the shape-based density design rule checking of the critical signal path nets before performing shape-based density design rule checking of other signal path nets.

7. The method of claim 6, wherein performing the shape-based density design rule checking of the critical signal path nets further comprises assigning three-dimensional track spacings based on timing slack thresholds of the critical signal path nets, and performing the fill insertion of metal fill shapes based on the timing slack thresholds of respective critical signal path nets to achieve a predefined minimum density threshold to satisfy density requirements in the IC layout.

8. The method of claim 1, and further comprising:
classifying, based on the slack stealing information, the signal path nets into three or more classes; and
limiting fill insertion of metal fill shapes based on the three or more classes.

9. The method of claim 8, wherein the signal path nets are classified into the three or more classes based on whether active metal shapes forming each of the signal path nets are critical active metal shapes or non-critical active metal shapes.

10. The method of claim 1, wherein performing shape-based density design rule checking of the metal shapes infrastructure further comprises assigning priorities of the active metal shapes forming the signal path nets into the metal shapes infrastructure based on the slack stealing information.

11. A system for integrated circuit (IC) design based on timing slack comprising:
a first design tool to access physical design data for an IC layout, wherein the physical design data comprises a netlist including active metal shapes of a metal shapes infrastructure forming signal path nets connecting different parts of the IC layout, and wherein the first design tool is to perform timing-based design rule checking of the physical design data to identify slack stealing information for the signal path nets; and
a second design tool to perform shape-based density design rule checking of the metal shapes infrastructure, based on the slack stealing information, to perform fill insertion of metal fill shapes to satisfy density requirements in the IC layout.

12. The system of claim 11, wherein the slack stealing information includes timing slack values for the active metal shapes of the metal shapes infrastructure, and wherein the slack stealing information indicates excess timing slack that may be distributed from one portion of a signal path net across one or more latches to another portion of that signal path net.

13. The system of claim 11, wherein the first design tool is to perform the timing-based design rule checking to identify the slack stealing information based at least in part on cross-hierarchy timing assertions.

14. The system of claim 11, and further comprising one or more tools to identify a set of the signal path nets that have no slack stealing available, and prioritize fill removal on the identified set of signal path nets for initial fill removal.

15. The system of claim 11, and further comprising one or more tools to identify slack stealing thresholds at which devices in one or more of the signal path nets can be downgraded to lower-power devices.

16. The system of claim 11, and further comprising one or more tools to classify, based on the slack stealing information, the signal path nets into three or more classes, and limiting fill insertion of metal fill shapes based on the three or more classes.

17. An apparatus for integrated circuit (IC) design based on timing slack comprising:
a processing device; and
memory operatively coupled to the processing device, wherein the memory stores computer program instructions that, when executed, cause the processing device to:
access physical design data for an IC layout, wherein the physical design data comprises a netlist including active metal shapes of a metal shapes infrastructure forming signal path nets connecting different parts of the IC layout;
perform timing-based design rule checking of the physical design data to identify slack stealing information for the signal path nets; and
perform shape-based density design rule checking of the metal shapes infrastructure, based on the slack stealing information, to perform fill insertion of metal fill shapes to satisfy density requirements in the IC layout.

18. The apparatus of claim 17, wherein the slack stealing information includes timing slack values for the active metal shapes of the metal shapes infrastructure, and wherein the slack stealing information indicates excess timing slack that may be distributed from one portion of a signal path net across one or more latches to another portion of that signal path net.

19. The apparatus of claim 17, wherein the memory stores computer program instructions that, when executed, cause the processing device to perform the timing-based design rule checking to identify the slack stealing information based at least in part on cross-hierarchy timing assertions.

20. The apparatus of claim 17, wherein the memory stores computer program instructions that, when executed, cause the processing device to identify a set of the signal path nets that have no slack stealing available, and prioritize fill removal on the identified set of signal path nets for initial fill removal.

21. A computer program product comprising a computer readable storage medium, wherein the computer readable storage medium comprises computer program instructions that, when executed:
access physical design data for an integrated circuit (IC) layout, wherein the physical design data comprises a netlist including active metal shapes of a metal shapes infrastructure forming signal path nets connecting different parts of the IC layout;
perform timing-based design rule checking of the physical design data to identify slack stealing information for the signal path nets; and
perform shape-based density design rule checking of the metal shapes infrastructure, based on the slack stealing information, to perform fill insertion of metal fill shapes to satisfy density requirements in the IC layout.

22. The computer program product of claim 21, wherein the slack stealing information includes timing slack values for the active metal shapes of the metal shapes infrastructure, and wherein the slack stealing information indicates excess timing slack that may be distributed from one portion of a signal path net across one or more latches to another portion of that signal path net.

23. The computer program product of claim 21, wherein the computer readable storage medium comprises computer program instructions that, when executed, perform the timing-based design rule checking to identify the slack stealing information based at least in part on cross-hierarchy timing assertions.

24. A method for integrated circuit (IC) design based on timing slack comprising:
accessing physical design data for an IC layout, wherein the physical design data comprises a netlist including active metal shapes of a metal shapes infrastructure forming signal path nets connecting different parts of the IC layout;
performing timing-based design rule checking of the physical design data to identify cross-latch and cross-hierarchy slack stealing information for the signal path nets; and
performing shape-based density design rule checking of the metal shapes infrastructure, based on the slack stealing information, to perform fill insertion of metal fill shapes to satisfy density requirements in the IC layout.

25. The method of claim 24, wherein the slack stealing information includes timing slack values for the active metal shapes of the metal shapes infrastructure, and wherein the slack stealing information is based at least in part on cross-hierarchy timing assertions and indicates excess timing slack that may be distributed from one portion of a signal path net across one or more latches to another portion of that signal path net.
